(19) United States
(12) Patent Application Publication
(10) Pub. No.: US 2012/0124058 A1
(43) Pub. Date: May 17, 2012

(54) SYSTEM AND METHOD FOR RATING ITEMS WITHIN THE ARTS

(76) Inventor: Edward Wachtel, New York, NY (US)

(21) Appl. No.: 12/946,115

(22) Filed: Nov. 15, 2010

(51) Int. Cl. G06F 17/30

(52) U.S. Cl. 707/748; 707/E17.045

(57) ABSTRACT

A system and method provides for judging the fine arts in a graded fashion. Information is stored in one or more fields including literature, cinema, plays, art, music and television in at least one database on at least one computer system. A database of experts is maintained in the computer system in one or more areas including literature, cinema, plays, music, art or mental health. A set of one or more categories within each of the fields is created and stored in the database. A set of one or more facets associated with each of the categories is created. The facets for each item of the categories in the fields stored in the database are rated by an expert associated therewith and stored within the at least one database. The ratings of the items are transmitted over the Internet for view by others for determining the merit or negative attributes of a given item.

### BACKGROUND OF THE INVENTION

This invention relates in general to an Internet based computer system and method of integrating the arts, e.g., art pieces, music, cinema, and literature, into an economy through use of information exchange over the Internet.

In today's economy, media prowess and gut feel to a large degree determine market value in pieces of the art. For contemporary art, we have a variety of different styles located in museums, with wealthy patrons and with those in society that appreciate particular pieces. However, earning a living as an artist is quite limited due to a lack of demand for quality pieces by the general public. Individuals spend more on cars, vacations and living room furniture then on art. Further, art movements appear to be heavily influenced by marketing skill, marketing dollars, personal charisma and individual contacts, limiting the role that the art itself plays in the movement.

For music, we do have a significant variety of ground breaking advances, for example jazz artists. This is a result of groups of purchasers that have a reasonable training in music or an inherent appreciation of its works, along with an economy that can cheaply produce a large variety of artist works. This production is done on CDs and on the Internet as digitally downloadable music. Music is also broadcast on radio, both satellite and land on a wide variety of channels. With continued advances in the Internet and satellite radio, production and access to musicians and their work will continue, as will the advances in music.

However, the majority of music sold and listened to in a number of nations is from a relatively small set of artists. These artists generally have charisma, an excellent expression of emotion and marketing skill, either themselves or from a producer. Some are fine musicians and express a depth of emotion. Others may have moderate or little musical skill and express simple feelings of sexuality, anger or other emotions. There are numerous professional artists with outstanding skill that find the market is closed to them due to lack of demand. This is often due to a lack of marketing skill, a lack of marketing money or a lack of discriminating knowledge on the part of the general population.

There are techniques to compare products. U.S. Pat. No. 6,266,649 describes a method to produce a group of items, each linked to a list of similar items. This method allows an expert user to find similar products. However, people without that expertise are limited to preferences of a majority of others with similar taste. There are also mathematical algorithms to statistically connect like products. These methods will offer similar products to products one is already aware of. However, it is often the case that one is not aware of outstanding products in the arts to compare with.

Artificial intelligence algorithms are often limited in scope, such as the moves on a chess board. The subtlety of a fine work of art versus a very good professional piece or an average piece is beyond current algorithms, in particular, because there are subjective considerations involved. To rate and form a uniform grading of art, music and literature requires a new method. To acquire an objective expression of value from subjective products requires tremendous knowledge in the area being judged, whether it is art, music, cinema or literature.

### SUMMARY OF TEE INVENTION

An Internet site based computer system is described to allow for an increased economic market for the arts, a graded scale for art value, a larger share of high quality fine arts and an opening to those producing the arts without the necessity for marketing funds or marketing expertise. The current market for the arts is often dominated by those individuals and institutions with large marketing funds. Further, often more complex pieces are difficult to assess and difficult to find. In opera and classical concerts the dominant shows are pieces produced hundreds of years ago, as opposed to modern compositions. A method is needed to turn the market toward modern pieces and bubble up the finest of the new pieces. Expert ratings of artistic pieces are saved inside a database for view by clients over the Internet. Graded assessments allow for a variety of quality price points. Categories of a given field of the arts and facets of each category are generated by the experts and saved in the database.

In a system where information in the fields of literature, cinema, plays, art, music or television is stored in at least one database on at least one computer system, a method for rating items in the fields of literature, art, cinema, music or television as having merit or negative attributes comprises the steps of maintaining a database of experts in the areas of literature, cinema, plays, music, art or mental health; creating a set of one or more categories within each of the fields; creating a set of one or more facets associated with each of the categories; rating the facets for each item of the categories in the fields by an expert associated therewith; storing the rating within the at least one database; placing the rating of the items for view over the Internet by others that would like to determine the merit or negative attributes of a given item.

A method for rating items in one or more fields selected from the group consisting of literature, art, cinema, music and television as having merit or negative attributes, the method comprising the steps of storing information in one or more fields selected from the group consisting of literature, cinema, plays, art, music and television in at least one database on at least one computer system; maintaining a database of experts in one or more areas selected from the group consisting of literature, cinema, plays, music, art or mental health; creating a set of one or more categories within each of the fields stored in the database; creating a set of one or more facets associated with each of the categories; associating an expert with each of the items; rating the facets for each item of the categories in the fields stored in the database by an expert associated therewith; storing the rating within the at least one database; placing the rating of the items for view over the Internet by others for determining the merit or negative attributes of a given item.

A system for rating items in one or more fields selected from the group consisting of literature, art, cinema, music or television as having merit or negative attributes, the system comprising at least one database on at least one computer system where information in the fields of literature, cinema, plays, art, music or television is stored; a database of experts in the one or more areas selected from the group consisting of literature, cinema, plays, music, art or mental health; a set of one or more categories within each of the fields; a set of one or more facets associated with each of the categories, wherein the facets for each item of the categories in the fields are rated by an expert associated therewith, the ratings stored within the at least one database; and a computer for placing the rating of the items for view over the Internet by others that would like to determine the merit or negative attributes of a given item.

It is an object of the invention to provide a method to place a quantitative assessment of the value of cinema, art, literature and music for use by clients wishing to purchase or use the product.

It is another object of the invention to enable assessment on a mass scale by use of computers and databases.

It is another object of the invention to grade assessment, so market prices can settle based on a quantitative assessment.

It is another object of the invention to create and grow markets for the fine arts of cinema, literature, music and art.

It is another object of the invention to give high quality artists, musicians, writers and directors easier access to the economic markets.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings.

FIG. 1 shows the client, server and database configuration over the Internet.

FIG. 2 shows the process of categorizing each field and rating of items within each category.

FIG. 3 shows the expert system interface for selection of items.

FIG. 4 shows the expert system interface for rating of an item.

FIG. 5 shows the client system interface for clients reviewing rated information.

FIG. 6 shows the expert database rating tables.

FIG. 7 shows the definitions for ratings for an example harmony facet of music.

FIG. 8 shows the flow of generating ratings for happiness for television and cinema.

FIG. 9 shows the database tables for television and cinema ratings.

FIG. 10 shows a voting user interface.

FIG. 11 shows a television network.

FIG. 12 shows a transformed data select from a database.

### PREFERRED EMBODIMENT

In describing the preferred embodiments of the invention illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

The invention offers a method of judging the fine arts in a graded fashion. Once graded, market forces can determine prices based on graded values. By use of the invention, the layman has expert guidance to very good and outstanding pieces.

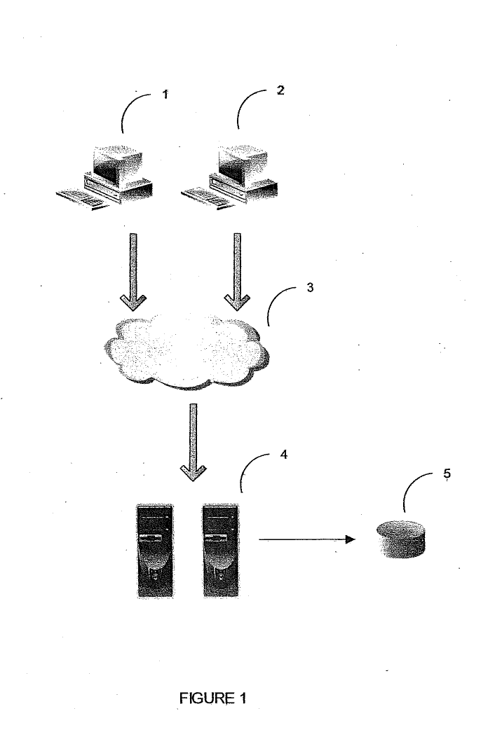

FIG. 1 shows a preferred network structure in accordance with one embodiment of the invention. The network structure includes client system 1 and expert system 2 such as microprocessor based systems, e.g., a computer including a display screen such as a PC or laptop, as well as other suitable systems such as PDAs, pocket PCs, cell phones and the like. The client system 1 and expert system 2 are connected through the Internet 3 to server system 4 that accesses expert rating tables on database 5. The server system 4 includes a microprocessor and may include one or more memory components such as the database 5.

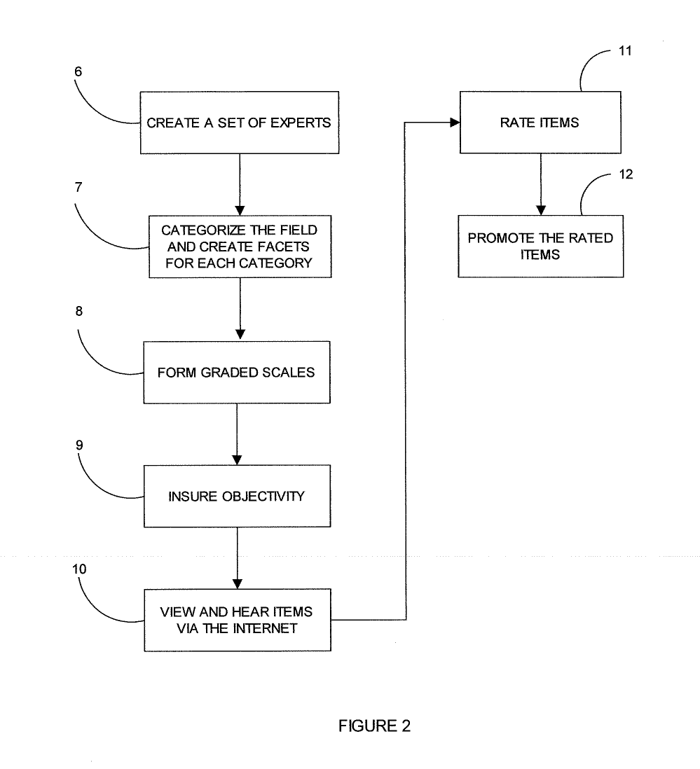

FIG. 2 gives a high level flow of the graded assessment process in accordance with one embodiment of the present invention. In step 6, a set of experts is brought together. It is the experts that create the categories, determine the attributes for each category and give the ratings. One area of experts contemplated are universities, another is professional organizations and another is graduates in a specific field, although other sources of experts are contemplated.

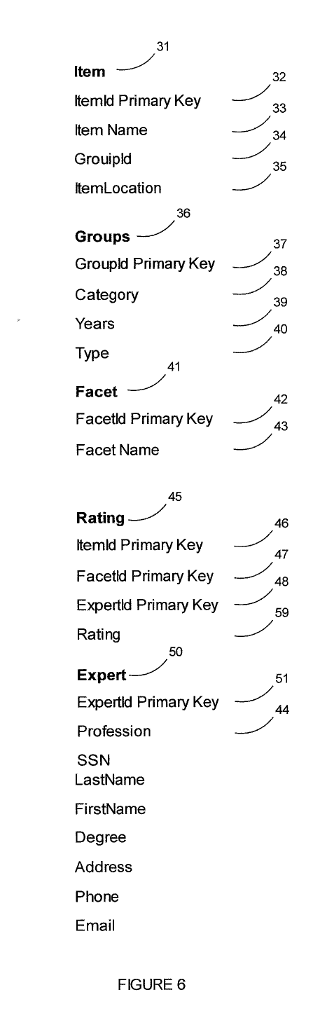

Taking the example of music, there are a number of colleges and universities across the country that offer music degrees. The professors and graduated students form a pool of expert judges in step 6. This pool of judges is recorded in database 5 FIG. 1, with expert table 50 FIG. 6. The expert id primary key 51 is used to determine whether full songs will be available for item table 31 in database 5, which is a specific song on the system with name item Name 33. When a judge logs into the system 2 of FIG. 1, a cookie is generated in his web browser, identifying him as a judge with an encrypted judge id. This cookie is checked to determine whether song item Name 33 will be played in full.

As an example, each judge can pick 10 pieces a month from an online listening screen of system 2 of FIG. 1, which contains links to music and video of music step 10 FIG. 2 and rate the pieces step 11. These ratings end up in database 5 table 45 FIG. 6. Because there would be numerous anonymous judges, objectivity, step 9, is achieved. Having a large pool of judges offers a second important advantage, the ability to create a repeatable result within a margin of error α. This is achieved by taking a random sample of judges of a size to create a statistically significant sample within the margin of error α. Standard hypothesis testing is one method to determine statistical significance. The sampling method and result analysis could be certified by an independent organization that specializes in statistics.

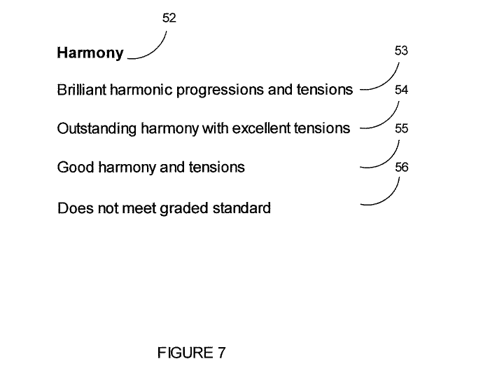

In this case an itemId, for example the “Abbey Road” album, 32 FIG. 6 is associated with a set of Expertids 51 FIG. 6 within a Rating table 45 FIG. 6. If we want to determine whether a rating of 9 or 10 out of a best rating of 10 has statistical significance, we can first take a null hypothesis, that the 9 or 10 is purely by chance, which would mean on a single trial, the rating parameter R for 9 or 10 out of 10 would have a probability P of 2/10 or 0.2. From table 45 FIG. 6 we count the total number of Rating 59 items from database 5 for the itemId, for the facet (e.g. say “Abbey Road” album, melody facet) and come up with for example 29 expertid ratings. We then do a count of the records with the itemId with a rating of 9 or 10. Let us say we found 10. We then look up in a binomial probability table stored in database 5 FIG. 1, for a dataset n of 29, the number of trials, and a probability P of 0.2 the chances of receiving, 10 or more ratings of 9 or out of a possible best 10 rating. The sum of the probabilities of getting 10 or more successes (rating of 9 or 10), in this case 4.9%, is compared to a site significance standard, say a probability of it having occurred by chance of less than 10%. If the sum is less then 10%, then we have a significant statistic. Given that a 9 or 10 is Brilliant for 53 FIG. 7 displayed on a screen in system 1 FIG. 1, we can then say that according to the site statistical standards the itemId, “Abbey Road”, is brilliant with respect to the facet of melody. Because the rating has been statistically verified, the rating should be able to be reproduced by an independent organization with a random set of experts. This makes for an objective rating on a graded scale (1 to 10) of what was previously a subjective rating, a rating of “Abbey Road” with respect to the facet of melody. This result can then be stored in database 5 of FIG. 1 in a table consisting of ItemId of FIG. 6, FacetId 42 of FIG. 6 and StatisticalRating (“Brilliant”). We can go a step further with statistics by certifying that the ratings are statistically sound. For example, we can have a statistician review samplings of a percentage of the rating types on the Internet site and verify that the results match the site's results. For example, the statistician may pick as one of the samples the “Abbey Road” album and verify the result of brilliant for the facet of melody is statistically correct. He would then check that the experts that gave the ratings are taken from a random sample of professional musicians that have either graduated from a music school or teach in a music school, within the United States. A user would be able to access the method of selection of the experts, thus knowing that this is a rating based on experts with the above qualifications, within the United States. The Internet site can then place a “statistically certified” emblem on the site.

To attract professional musicians to the site and offer professional correlations to clients through display 1 FIG. 1, musical pieces within the site could be correlated by ratings for the musician population, expertid 51 FIG. 6 in database 5 FIG. 1. By correlating the pieces, when a musician X wants to listen to music or a client through a display in system 1 FIG. 1, rather than randomly listening to pieces, they can be offered expertid 51 correlated pieces that they would be likely to enjoy. One method of accomplishing this is to do a root mean square error (RMSE) between each itemId 32 in database 5 FIG. 1 and all other itemIds for their associated Ratings 44 in database 5 FIG. 1. For example for itemId A and itemId B, for all professional musicians that have rated A and B, for Rating R the RMSE would be the square root of the sum of 1 to n of (RAn−RBn)²/N, where N is the number of ratings and is calculated if a minimum value N is available. If an RMSE is less then a predetermined value, say 1, then the items can be considered correlated. Thus, if a musician has listened to itemId A and wants more music like itemId A, correlated items can be given to him, correlated from the professional musician group. Likewise, if a client wants musician correlated pieces similar to itemId A, he can be given a list of pieces in step 12 through client display 1 of FIG. 1. When a piece of music is purchased, this list of correlated pieces can be used to present other pieces of probable interest.

Another method to correlate musical piece ratings, would be to correlate the professional musicians and then find other musical pieces that the correlated musicians have highly rated. For example, for a given musician X expertid 51 FIG. 6, database 5 of FIG. 1, find the five musicians that have the most common ratings Rating 44 FIG. 6, database 5, with respect to X. For example if X has ratings for musical pieces, itemId FIG. 6, A of 1, B of 5, C of 3, D of 4, find the 5 musicians that have rated one or more of A, B, C, D most often the same as compared to other musicians. Thus, for each expertid of Rating table 45, if they have rated an itemId 46 for A, B, C, D the same as musician X, then increment a counter for the expertid. The five musicians with the highest counters are the most alike with respect to musician X. Then, find other pieces that the five musicians have most often rated highly. For example select all itemIds 46 for the five musicians that have ratings of 4 or 5 out of 5, 5 being the highest. Group these itemIds by itemId and count how many records are in each itemId group. The top five largest counts that musician X has not rated, can be offered to musician X as possible pieces to enjoy. Likewise, if a client wants musician correlated pieces similar to itemId A, he can be given a list of pieces in step 12 through client display of system 1 of FIG. 1.

The site could promote the highest mean ratings by professionals, step 12 FIG. 2 and display it to the client in system 1 FIG. 1. Literature, plays and art can likewise use the same process on sites that sell these products. For literature and plays, each book or play can be posted for rating steps 10 and 11. Experts would be graduates of English step 6. For art, high definition video can be used, along with a video or written introduction to the piece by the artist step 10 through a display in system 2 FIG. 1. Graduates of art would be the experts step 6.

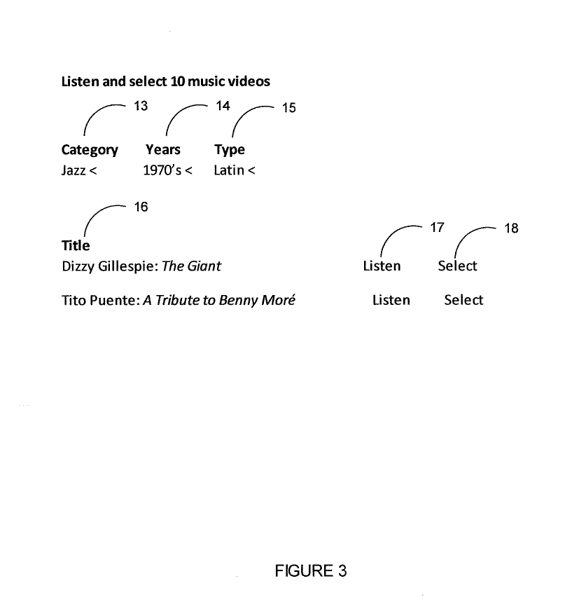

Another method of offering expertids 51, in this case professional musicians, items to rate is shown in FIG. 3. The user interface is controlled by Expert server System 4 FIG. 1 and shown to the musician through display in system 2 FIG. 1. The musician is given a choice of item names 33 FIG. 6 based off of category 13, years 14 and type 15 to choose from. The item set is retrieved from database 5 FIG. 1 by associating the Groups table GroupID key with the Item table GroupID based on the choices of the musician of category 38, years 39 and type in table Groups. The expert then listens to titles 16 within this group by pressing the Listen button 17. If he wishes to select this piece and rate it, he presses the Select button 18.

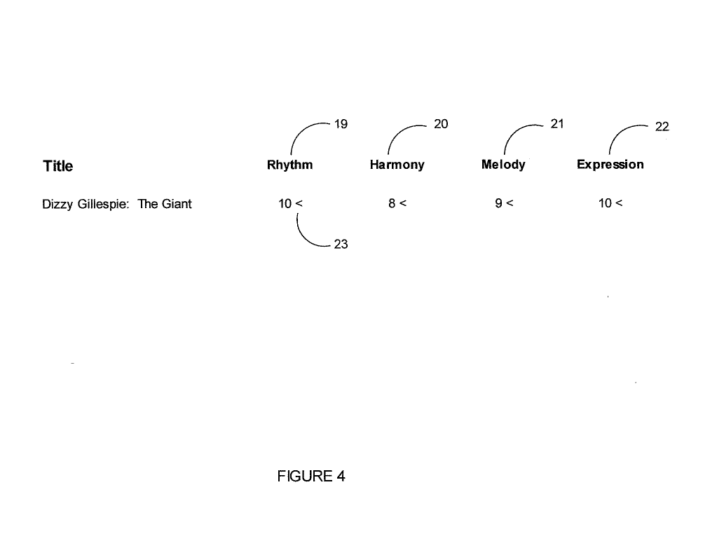

Assuming the expert has selected title Dizzy Gillespie: The Giant, popup Window FIG. 4 is shown. This window gives the expert facets Rhythm 19, Harmony 20, Melody 21 and Expression 22 to rate. Each facet is a FacetId 42 in table Facet 41 of database 5 FIG. 1. In the case of Rhythm, dropdown 23 is used to rate The Giant from 1 to 10 in terms of rhythm, 10 being the highest rating and 1 the lowest. This rating information is saved to Rating table 45 in database 5 FIG. 1, which brings together records consisting of the itemId 46 (Dizzy Gillespie: The Giant), Facetid 47 (rhythm, harmony, melody or expression), expertid 48 (the expert that gave the rating) and the rating itself 59 (1 to 10).

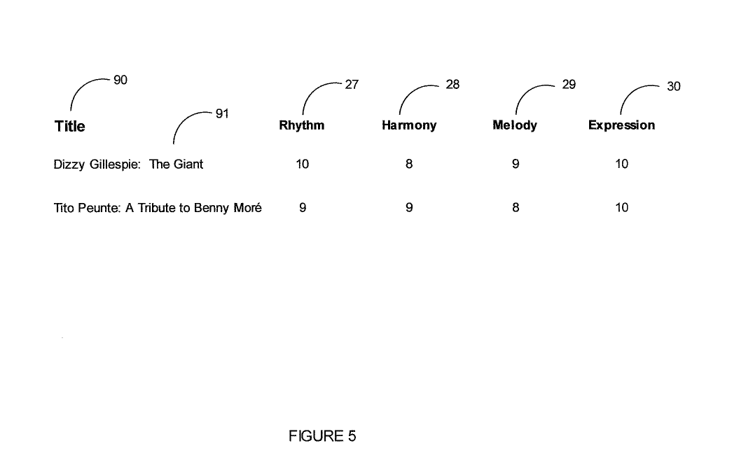

FIG. 5 shows the display to a client through client system 1 FIG. 1. The client chooses Category 24, Years 25 and Type 26 from dropdowns. In this case Jazz, 1970s and Latin are chosen. Two recommended titles are shown along with the mean ratings from the experts for the facets Rhythm 27, Harmony 28, Melody 29 and Expression 30. This is accomplished by transforming base information located in tables of FIG. 6 and stored in database 5 of FIG. 1. All groupids 37 for the jazz category 38 for the years 39 of 1970s and the type 40 of Latin are retrieved. Item Names 39 (e.g. Title 90 of Dizzy Gillespie: The Giant 91) and itemIds 32 are retrieved for the groupids 37 that are equivalent to Item 31 Groupid 34. Next, for each Facetid 42 (in this case Rhythm, Harmony, Melody and Expression) and each itemId 32 retrieved, a set of ratings 59 are retrieved from Rating table 45 where FacetId 47 is equal to said Facitid 42 and ItemId 46 is equal to itemId 32. This set is grouped by itemId, facetid and the rating is averaged, giving the average ratings (e.g. the average ratings for Dizzy Gillespie: The Giant 91). In this case the top 2 item names (e.g. Titles 90) are given based on the top 2 averages of the facet average ratings (in this case the average of the ratings for Rhythm 27, Harmony 28, Melody 29 and Expression 30).

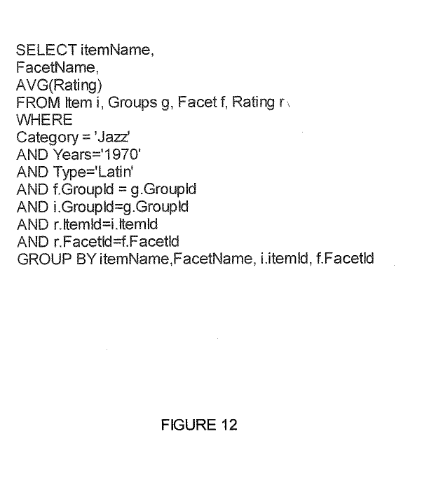

Rating information is saved in tables shown in FIG. 6, stored in database 5 of FIG. 1. Each expert is assigned a unique expertId 51 within the Expert table 50. Each item, in this case music title, is assigned a unique itemId 32. The itemName 33 is the name of the title, for example Dizzy Gillespie: The Giant. The GroupID 37 is composed of a Category 38, Years 39 and Type 40; for example of Jazz, 1970's and Latin. The ItemLocation 35 points to a file on disk containing the music. There are a set of facets associated with each Group. As an example, in FIG. 5, for a group composed of Jazz, 1970's and Latin, the facets are Rhythm 27, Harmony 28, Melody 29 and Expression 30. In FIG. 6 individual facets are located in the Facet table 41 with a given FacetName 43, for example Harmony. FIG. 12 gives a select to acquire the ratings for Rhythm, Harmony, Melody and Expression for Latin jazz in the 1970s.

Each rating by an expert for an item is saved in the Rating table 45, located in database 5 of FIG. 1. A given rating includes an item pointed to by the ItemId 46, an Expert pointed to by the ExpertId 48, a facet pointed to by the FacetId 47 and a Rating 49, in this case a number from 1 to 10.

FIG. 7 shows as an example of a facet, Harmony 52. The definitions of the graded ratings 1 to 10 are shown in items 53 through 56.

In FIG. 2 steps 7 and 8, we need a set of judges that are looked up to by the community of experts to split the field, in this case music, into categories and facets. Taking the music example, we can elect judges from professors and graduated students of music.

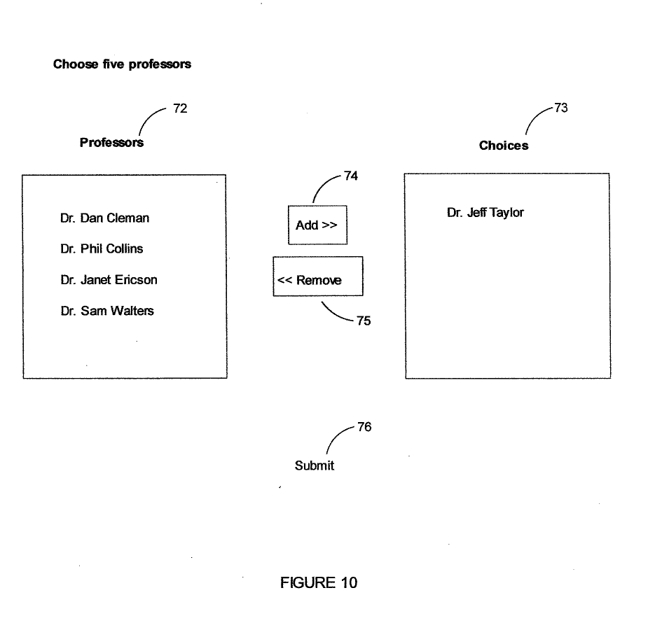

In FIG. 10, for a given set of universities, we can use an anonymous vote from the students and teachers for a representative, where 40% of the weighted vote will consist of the senior and graduate student classes and 60% of the vote will come from the professors. A given professor can opt out before the vote, if they do not wish to be voted as a judge. Each voter can place 5 votes. To select a judge the professor in column Professors 72 is highlighted. Pressing the Add >> button 74 moves the professor to the Choices 73 column, which means a vote for the professor as a judge. If one changes their mind and wants to remove a voted for professor, one highlights the professor in the Choices 74 column and presses the << Remove 75 button. When an individual has completed casting their votes, he presses the Submit 76 button. The voter type is determined by the Expert table 50 FIG. 6 Profession 44 attribute. For professor, the attribute is professor; for graduate student the profession is graduate student. Depending on this attribute, once submitted, the vote is multiplied by 0.6 for professor or 0.4 for graduate student and stored in a table Category Votes containing the expertid 51 of the person voted for, the expertId of the voter and the said weighted vote. In calculating the e votes for the representative to split the field into categories and facets, this table is grouped by the expertId of the person voted for and the associated weighted vote is average for each group. The top averaged expertIds become the representatives.

We take the top 10 individuals from each school. These individuals choose a chairman. The chairman forms committees from the judges. The chairman and committees divide the music field into categories. These categories are viewed in the dropdowns Category 24, Years 25 and Type 26 in FIG. 5. They then create the facets of each category. For group Jazz 24, 1970's 25, Latin 26, the facets are Rhythm 27, Harmony 28, Melody 29 and Expression 30. Facets might be limited to 5 or 10 and weighted to form a single rating. For literature and plays, the experts in the above method might be English professors; for art, art professors; for the television and cinema example, cinema graduates or psychology professors.

Another use of this invention is to aid society in viewing television and cinema shows that promote ideas that will probably produce happiness. The rating is based on whether the plot, characters and theme, if implemented by real people, would probably bring the people more happiness; on the other side, providing a warning for those shows, whose ideas if implemented by real people, would probably bring misery. This type of objective is particularly useful for children, as they are particularly open to ideas, both positive and negative and incorporate these ideas into their lives.

Mental health professionals in private practice have shown clients their ability to provide useful information. If one makes the expert judging a show a mental health professional in private practice and the question whether a show's ideas are likely to produce happiness or misery, we have a resource to judge whether to see a film or not and whether to allow our children to see a film.

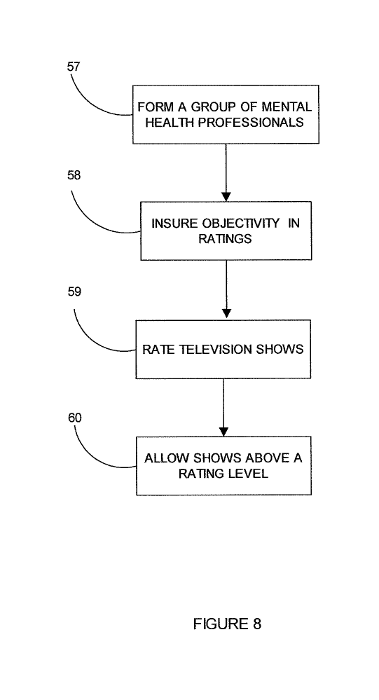

FIG. 8 shows a flow of this scenario. The experts, mental health professionals in private practice 57, rate shows from −10 (apt to cause misery) to +10 (apt to cause happiness) per facet, for example aggression, sexuality and relationships. The mental health professional could grade a show from −10 to 10 based on a user profile. An example profile might be a female child age 12. Profiles could be obtained from a questionnaire provided over the Internet or provided through a television receiver box. A rating of 0 would mean ideas in the show if applied to one's life and as expressed in the show are not likely to have any effect on happiness either positive or negative. A rating of 10 means ideas in the show are expressed in a strong fashion and are highly likely to produce happiness if applied to an individual's life. A rating of −10 means ideas in the show are expressed in a strong fashion and are highly likely to produce misery if applied to an individual's life.

A cable company might offer this service per logged in user on the cable box. Referring again to FIG. 8 the cable company could hire 40 anonymous solo practitioners part time step 57 to rate the television shows from −10 to 10 step 59 per facet. Having anonymous solo practitioners makes for objectivity 58, as they could not be contacted by shows being rated. If a child is logged in, only those shows above a certain rating would be allowed in step 60. Perhaps a parent would choose 0 on Saturday mornings to allow themselves extra sleep and 4 during the week step 60.

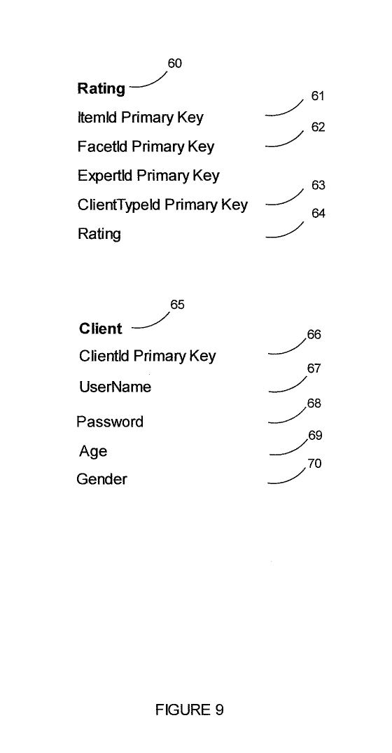

FIG. 9 shows the modified Rating table 60 for television and cinema. This table has been modified from FIG. 6 table 45. Since the ratings are per logged in user including a UserName 67 and encrypted Password 68, a ClientId 63 has been added to the Rating 45 table to produce the Rating table 60. This allows a Rating 64 distinction based on a client's age and gender. The ClientId 63 is from the Client Table 65 ClientId 66, which contains the Age 69 and Gender 70 of the Client. The Groups 36 table, Item 31 table, Facet 41 table and Expert 50 table is used in conjunction with the logged in client, ClientId 66 and the revised Rating table 60 to acquire a rating. To acquire ratings for a particular show all GroupIds 37 for the Category 38 (e.g. sitcom) for the Years 39 (e.g. 1990s) and the Type 40 (e.g. comedy) are retrieved. Item Names 39 (e.g. The Simpsons) and ItemIds 32 are retrieved for the said GroupIds 37 that are equivalent to Item 31 Groupid 34. Next, for each Facetid 42 (in this case aggression, sexuality and relationships) and each ItemId 32 retrieved, a set of ratings 64 are retrieved from Rating table 60 where FacetId 62 is equal to the Facitid 42 and ItemId 61 is equal to the itemId 32 and ClientId 63 is equal to the ClientId 66. This set is grouped by ItemId 61, FacetId 62, ClientId 63 and the rating is averaged (e.g. the average ratings for facets aggression, sexuality and relationships for The Simpsons).

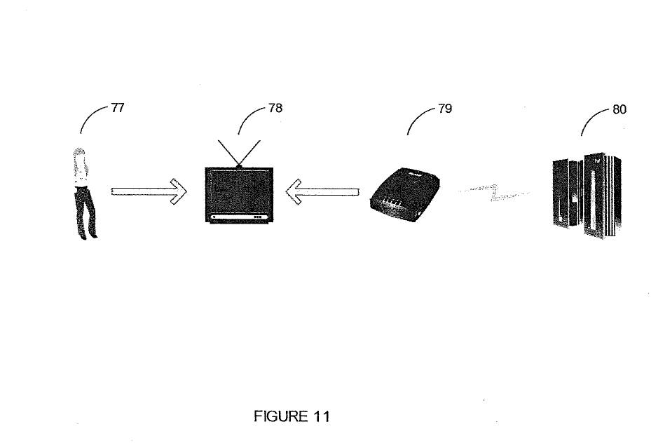

FIG. 11 shows the hardware implementation of the happiness ratings. A client views a television 78 connected through a television receiver box 79. Shows are provided by cable or satellite through the receiver box by a television show provider 80. In this example the profile is input by the client 77 through the television 78. The profile is generated by the television show provider 80 and sent to the television through the receiver box 79. The health care professional is hired by the television show provider 80 or a related provider that transmits through television show provider. Shows are rated as likely to produce happiness or likely to produce misery. For the given child in this example, perhaps only shows not rated as 1 or above would be blocked.

Accordingly, it can be seen that an Internet based rating system by experts in a given field offers the market economy an expert assessment of a given product in the arts. By using experts on ideas that bring happiness, television, videos and cinema can be identified as promoting ideas for happiness or promoting ideas for misery. This is especially important for children.

By having expert ratings of products, the product itself becomes important, rather than marketing prowess or connections. Further, the markets open to a variety of products that otherwise may not have the money or marketing to reach the public.

Although the description above contains many specificities, these should not be construed as limiting the scope of the invention but as merely providing illustrations of some of the presently preferred embodiments of this invention. Various other embodiments and ramifications are possible within its scope. Thus the scope of the invention should be determined by the appended claims and their legal equivalents, rather than by the examples given.

1. In a system where information in the field of literature, cinema, plays, art, music or television is stored in at least one database on at least one computer system, a method for rating items in the field of literature, plays, art, cinema, music or television comprising the steps of:
providing a database of experts in the area of literature, cinema, plays, music, art or television;
providing one or more categories associated with at least one of the fields;
providing one or more facets associated with at least one of the categories;
receiving within the database a rating of at least one facet for each item in at least one category in at least one field by an expert associated therewith; and
placing the ratings of the items in the database over the internet responsive to the computer system for view by others.

2. The method of claim 1 wherein said rating is on a graded scale.

3. The method of claim 1 wherein said rating is determined to be statistically significant within a margin of error.

4. The method of claim 3 further including certifying as statistically sound a sampling methodology and results analysis.

5. The method of claim 1 wherein said items are correlated to each other based on ratings of said experts.

6. The method of claim 1 wherein additional items to view are based on correlating as similar experts with each other and presenting additional said items to view to a given expert based on items viewed by said correlated as similar experts.

7. The method of claim 1 wherein said providing one or more facets responsive to a determination by said experts in said field.

8. The method of claim 1 further comprising the step of periodically reviewing said one or more categories and said one or more facets within a given said field; and adding or removing, or modifying categories or facets.

9. The method of claim 1 further comprising cross referencing items from experts to items purchased or viewed by users for offering like items.

10. The method of claim 1 further including receiving ratings of said items by said experts based on the likelihood of an item's ideas, if implemented by the viewer, causing happiness or causing unhappiness for the viewer.

11. The method of claim 10 wherein the rating is on a graded scale.

12. The method of claim 10 wherein the expert is a mental health professional or a graduate in literature.

13. The method of claim 10 wherein said items comprise televisions shows, and further including blocking said television shows by a television receiver based on said rating of the show.

14. The method of claim 13 wherein users log into said receiver and expert ratings are based off of the logged in user attributes of age and gender.

15. The method of claim 14 wherein said television receiver blocks shows based on said rating and said logged in user.

16. A method for rating items in one or more fields selected from the group consisting of literature, art, cinema, music and television as having merit or negative attributes, said method comprising the steps of:
storing information in one or more fields selected from the group consisting of literature, cinema, plays, art, music and television in at least one database on at least one computer system;
providing a database of experts in one or more areas selected from the group consisting of literature, cinema, plays, music, art or television;
providing one or more categories associated with at least one of the fields stored in the database;
providing one or more facets associated with at least one of the categories;
associating an expert with each of the items;
receiving within the database a rating of at least one facet for each item in at least one category in at least one field stored in the database by an expert associated therewith; and
placing the ratings of the items in the database over the internet responsive to the computer system for view by others.

17. The method of claim 16 wherein said items are correlated to each other based on ratings of said experts.

18. The method of claim 16 wherein additional items to view are based on correlating as similar experts with each other and presenting additional said items to view to a given expert based on items viewed by said correlated as similar experts.

19. A system for rating items in one or more fields selected from the group consisting of literature, art, cinema, music or television as having merit or negative attributes, said system comprising:
at least one database on at least one computer system where information in the fields of literature, cinema, plays, art, music or television is stored;
a database of experts in one or more areas selected from the group consisting of literature, cinema, plays, music, art or mental health;
one or more categories in the at least one database associated with each of the fields;
one or more facets in the at least one database associated with each of the categories, wherein the facets for each item in the categories in the fields are rated by an expert associated therewith, the ratings stored within the at least one database; and
a computer for placing the ratings of the items for view over the internet by others.

20. The system of claim 19 wherein a television receiver blocks television shows based on said rating of the show.

21. The system of claim 20 wherein users log into said receiver and expert ratings are based off of the logged in user attributes of age and gender.

22. The system of claim 21 where said television receiver blocks shows based on said rating and said logged in user.
